(19) United States
(12) Patent Application Publication
(10) Pub. No.: US 2007/0173385 A1
(43) Pub. Date: Jul. 26, 2007

(54) Method and device for using weights and massage on bodies

(76) Inventors: Erez Cohenca, Hod Hashoron (IL); Merav Cohenca, Hod Hasharon (IL); Uzi Ezra Havosha, Tel Aviv (IL)

Correspondence Address: UZI EZRA HAVESHA & PARTNERS, HADAR-DAFNA HOUSE 39 SHAOUL HAMELECH STREET, TEL AVIV, 64928, omitted

(21) Appl. No.: 11/657,079

(22) Filed: Jan. 24, 2007

(30) Foreign Application Priority Data
Jan. 26, 2006 (IL) 173366

(51) Int. Cl. A63B 21/065

(52) U.S. Cl. 482/105

(57) ABSTRACT

Weights for adjustable attachment to a body for the purpose of exercise, health, convalescence, therapeutics, massage and/or introduction of liquids to the skin or body. Ability to fill container weights with liquids, gels or solids to attain different weights for different parts of the body.

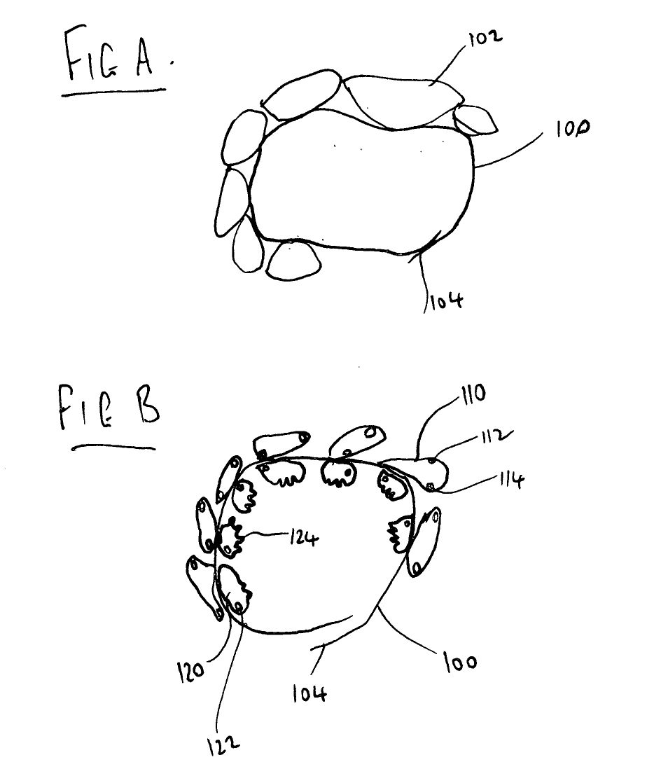

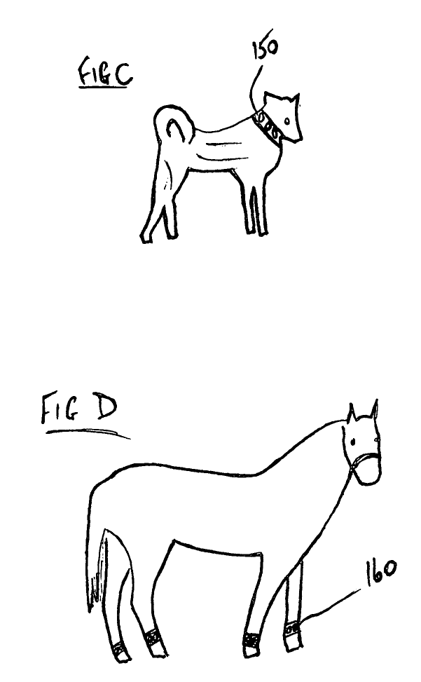

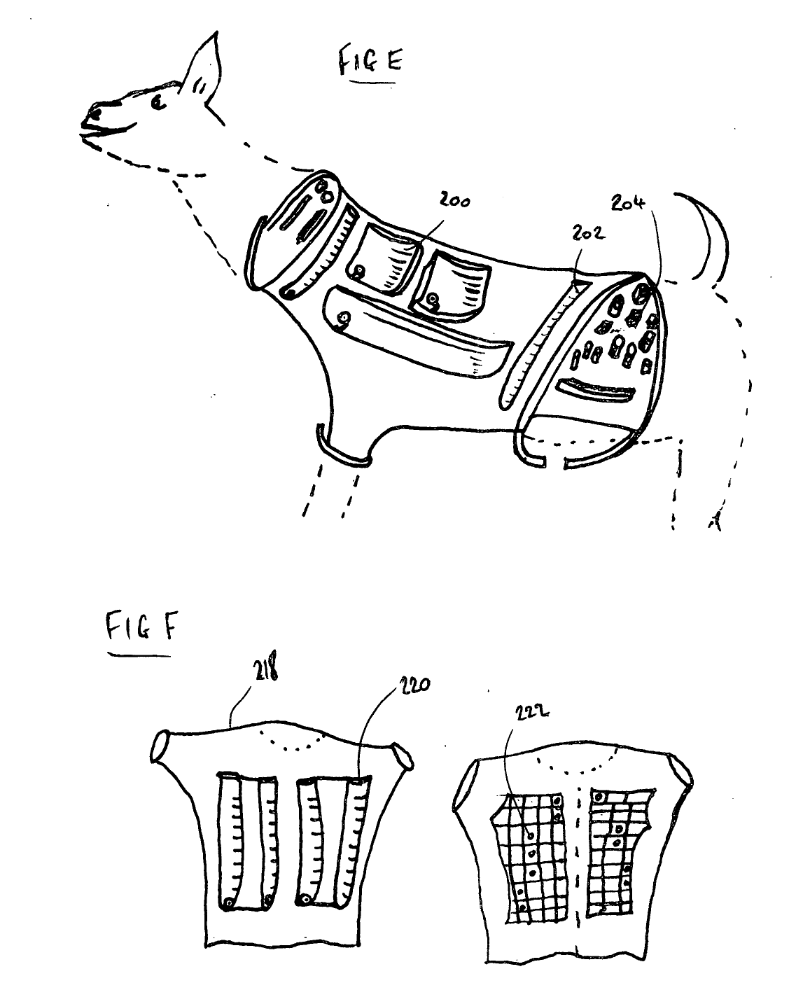

### FIELD OF THE INVENTION

This invention relates to the field of weights attached to people and/or animals and in particular such weights attached for the purpose of exercising and/or massaging the muscles and/or other sections of the body.

### BACKGROUND OF THE INVENTION

For a variety of reasons it can be necessary or desirable for animals to have weights attached to their bodies. This can be a treatment by a veterinary doctor or by the animal owner who determines that the animal would benefit from such weights. In this application for this invention, reference is generally made to animals although the invention can also apply to humans.

It is often desirable to cause an animal to do more exercise than just walking naturally. Weights added to the body of the animal increase the beneficial effects of walking. Massage of the body or limbs while walking can have added beneficial effects of muscle toning and/or fat reduction. Ailments known to humans and animals, like heart problems, muscle weakness or excess fatty tissue can be alleviated by causing the body to exercise with weights, especially where such weights are attached to that part of the body that needs to be strengthened.

Another example of such a need for weights for an animal is where the animal had a broken leg and the bone has healed but the muscle needs strengthening. Weights attached to such a leg assist the healing process and strengthen weak muscles. Also, in a case such as this, the addition of massage, benefits and speeds recovery of such a weakened muscle.

Another example could be where an animal has excess fatty tissue on its body and it is determined that the animal should lose some of the fat. When the animal wears weights especially when walking or other exercise, it will lose fat faster than without wearing weights. Here again, it is well known in the art, that massage has the effect to help to reduce excess weight.

The massage effect can enhance the use of the weights but in some instances is not beneficial and therefore in this invention the massage effect is optional.

Until the revelation of the present invention, the use of weights on animals has been cumbersome. Often the weights are not adjustable but even when they are adjustable, they are not attachable locally on a particular limb, when that is desirable. Most of the previous art has the weights fixed on a vest that is worn by the person or animal. This has the disadvantage of applying the weight to a relatively large section of the body and not to a specific limb that needs strengthening. Furthermore, such a vest does not have a beneficial massage effect. Indeed, it is designed to have as little rubbing effect as possible as seen in U.S. Pat. No. 5,127,213 quoted hereinafter where it speaks of a blanket-type member having a cushioning effect for the comfort of the animal. The inventors of the present invention found that by having a massage effect (which has a soothing and beneficial effect and not an abrasive effect) was an enhancement to the effects of the weights thereby encouraging the healing, muscle building and/or slimming effects.

U.S. Pat. No. 6,912,976 issued to Everett reveals an exercise harness for an animal which comprises three elements: (a) a web of flexible material adapted to be affixed to the body animal of the in a region adjacent to the animal's front legs and/or rear legs; (b) at least one strap, connected to the web and adapted to retain the web on the animal; and (c) a measured weight attached to the web by a holding device, such as a pocket, clip or the like.

U.S. Pat. No. 5,127,213 issued to Petronio reveals a blanket-type member supports weights in either a fixed or variable relation and is disposed on the back of an animal for training and conditioning purposes. The blanket-type member has a cushioned undersurface for the comfort of the animal and is disposed on the animal's back over an undercover to prevent chafing and the like as the animal moves about with the blanket-type member on its back.

U.S. Pat. No. 4,268,917 issued to Massey (U.S. Class 2/102) reveals a variable weighted vest for use in exercising, such as jogging, skating, bicycling and horseback riding.

U.S. Pat. No. 4,344,620, which was issued to Debski (U.S. Class 272/119), reveals an exercise vest that has interconnected watertight compartments that define a vest for supporting a fluid weight medium from the shoulders and about the upper torso of a human exerciser.

U.S. Pat. No. 4,382,302, which was issued to Watson (U.S. Class 2/102), reveals a weighted training vest having constant weight distribution.

U.S. Pat. No. 4,394,012, which was issued to Egbert (U.S. Class 272/119), reveals a weighted exercise vest that selectively allows weight capsules to be inserted into vest pockets. The vest is designed to allow free movement of the arms and is adapted to be worn while participating in conventional athletic activities, such as volleyball, basketball, racquetball, tennis and the like.

U.S. Pat. No. 4,602,387 which was issued to Zakrsewski reveals a weight vest incorporating means for wearing an adjustable amount of weight for purposes of weight resistance training.

Finally, US Patent Application No. 20030177984 reveals elongated weights which are hollow tubes, such as vinyl or plastic tubes, that may be filled with material such as sand or other granular material, or liquid material. The tubes may be permanently sealed after being filled with weighting material, or may be openable and closable so that a user, may, as desired, empty, fill, or partially fill the tubes.

These and related patents and patent applications reveal a variety of methods for applying weights to bodies but none of them combine the benefits of weights with massage as is revealed in the present invention

The present invention comes to combine the benefits of a flexible adjustably weighted device that can attach to any part, limb or body of an animal or person using same, with, optionally, an adjustable massage effect.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

The present invention comprises a container or bag or series of bags of various sizes and shapes, which can be strapped or otherwise attached to the animal.

One aspect of this invention calls for two tiers of bags or other kind of container. Alternatively, there could be one bag or container that is divided into two separate compartments, the upper section and lower section. The upper one (those furthest from the body) having all or some of the said bags or containers filled to create the desired weight. These bags or containers would be attached to the upper side of the belt, or the upper side of the single bag or container. The lower layer, being adjacent to the body, made of a bag or series of bags or containers where all or some of them can be filled with liquid and/or air. These lower layer of bags or containers have a three fold purpose, namely, to help grip the limb or body so that the whole device stays in place during movement of the body, secondly to add weight and thirdly to create the massage effect when desired. These lower layer bags or containers can have an extra protrusion or protrusions that could be inflatable together with the bag or container or independently of the bag or container. The main purpose of the said protrusion would be to increase the effect of the massage.

The whole device of bags or containers is made in different sizes so that it fits around the part of the particular limb that will most benefit from the said weights and/or massage.

In another aspect of this invention, each bag or container of the upper layer, has a removable bung toward its top for inserting liquid, gel, dry sand or other suitable material, into the bag and another removable bung towards its base for removing the said liquid, gel, dry sand or other suitable material. The desired weight can thereby be easily achieved and if needed, the weight can be increased, decreased or redistributed with ease.

The bags or containers can be calibrated into liters or parts of liters. When water is the liquid inserted into the bags or containers, every liter represents a kilogram of weight. When other substances are used then their weight/volume ratio can be established and written on the device of this invention, to ease the calculation how much weight is being applied at any time.

In yet another aspect of this invention, the bags or containers are filled and sealed. They therefore have a pre-determined weight and can be attached or removed as desired. The overall weight applied to the body or limb, can be adjusted by adding or removing the said sealed bags or containers. The said attachment is by fitting into pockets made for that purpose, velcro type hooks or any other suitable method.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a diagram of a belt of this invention with fixed weight bags attached.

FIG. B is a diagram of a belt of this invention with refillable weight bags and air/massage bags attached.

FIG. C is a diagram of a dog with this invention around its neck.

FIG. D is a diagram of a horse with this invention attached to its leg.

FIG. E is a diagram of a dog with various options of this invention, including attachment of different kinds of weights to different parts of the animal's body.

FIG. F is a diagram of a vest for use by humans showing the front side with one kind of weight and the backside with another kind of weight, as will be described below.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

FIG. A is a diagram of the weight belt 100 and its closing device 104. The belt 100 closes by any suitable means for example, buckle and clasp or velcro type attachment. The size of the belt could vary to fit any part of the body or limb. The bags 102 are of various sizes and are fixed weight bags. They are attachable and detachable for the purpose of placing the required weight on the animal. The method of attachment of the bag 102 to the belt 100 can be by any suitable means, for example, closeable pockets or velcro type of attachment.

FIG. B is a diagram of the weight belt 100 of this invention with weight bags 110 that have a filling bung 112 and an emptying bung 114. These bungs are to stop up the holes through which the weighting material (for example water, gel, sand or the like) is inserted and extracted according to the weight required. The weight bags 110 are on the outside of the belt 100, which is the side furthest from the body of the animal.

On the inside of the belt 100 are affixed the air bags 120 which could have a valve 122 for filling the said bags with air and letting out the said air when necessary. These air bags 120 perform up to three functions namely, firstly, to grip the animal's limb firmly and prevent the belt 100 from moving from its designated place while the animal is in motion. Secondly, to massage the animals body or limb at the place of contact with the bags. This massage effect is achieved by means of the pressure created against the body or limb of the animal by the bulging inflated bag. These air bags 120 are pressed onto the animal's body or limb by the weights 110 and when the animal walks or otherwise moves, the massage effect occurs.

The said massage effect can be intensified by the air bags 120 having protrusions 124 that rub against the animals body or limb. These protrusions can be part of the bag 120 and therefore inflate together with the bag 120 or alternately, they can have a separate filling valve and then be inflated independently of the main bag 120.

FIG. C is a diagram of a dog with weights and massage devices of this invention attached around its neck 150. As the dog moves the said weights move back and forth pressing down on the massage devices which are next to the body of the dog, thereby creating the massage effect.

FIG. D is a diagram of a horse with the said weights 160 attached around its ankles.

FIG. E is a diagram of an animal wearing various embodiments of this invention. There are refillable containers 200 of various sizes. Also, a tubular shape with calibrations 202 to show the quantity or weight of liquid or other material in the container. The underside of the said weights 204 can comprise bags or containers of air with or without protruding parts to increase the massage and gripping effect. What is shown in FIG. E 204 is the inside view of the weights that are on the other side of the animal as if the body of this section of the animal were transparent.

FIG. F is a diagram of a vest 218 worn by a person with calibrated containers 220 on the reverse side and removable weights 222 on the front side. Such weights 222 can be moved to any part of the checkered area of the vest or have more weights added or removed as desired by the user.

The present invention is not intended to be limited to the embodiments described above, but to encompass any and all embodiments within the scope of the following claims:

1. A method and device comprising
a) a system of weights that is removably attachable and adjustable to fit a body or part of a body,
b) the said weights attached in such a way that are in contact with the said body or said part of the body and
c) a means to fill and to empty the said weights with substances wherein the said weights are adjustable in size and in number,
whereby the said weights will strengthen the muscle, flesh or bone of the said body or part of the said body, and/or lose fatty tissue from the said body or part of the said body.

2. A method and device as claimed in claim 1 wherein the said body or part of the said body is that of a human.

3. A method and device as claimed in claim 1 wherein the said body or part of the said body is that of a living creature other than a human.

4. A method and device as claimed in claim 1 wherein the said weights are in the form of bags.

5. A method and device as claimed in claim 4 wherein the said weights are in the form of containers.

6. A method and device as claimed in claim 5 wherein the said weights are capable of being filled and emptied by means of openable and closable stoppers.

7. A method and device as claimed in claim 5 wherein the said weights are filled with liquid.

8. A method and device as claimed in claim 5 wherein the said weights can be filled with gel, sand or similar substances.

9. A method and device as claimed in claim 5 wherein the said weights are calibrated, to suit different substances (like, liquid, gel, sand etc.) so that the weight of each container is known.

10. A method and device as claimed in claim 5 wherein the said weights are filled through a closable hole at or near its upper end.

11. A method and device as claimed in claim 5 wherein the said weights are emptied via a closable hole at or near its lower end.

12. A method and device as claimed in claim 5 wherein the said weights are of the same size or a variety of sizes.

13. A method and device as claimed in claim 5 wherein the said weights have a pre-determined weight.

14. A method and device as claimed in claim 13 wherein the said weights or said bags are attached to the said body or limb by an adjustable method to fit different parts of the body or different sized limbs.

15. A method and device as claimed in claim 13 wherein the said weights are attached to the said body or limb with a strap and buckle.

16. A method and device as claimed in claim 13 wherein the said weights or said bags are attached with some detachable method, for example, velcro type connection or in pockets of a vest that is attached to the said body or limb.

17. A method and device comprising
a) a layer of containers removably attachable to a body or part of the said body being weighted or capable of being weighted,
b) inflatable containers being adjacent partly or wholly to the first said containers and positioned partly or wholly between the said weighted containers and the said body or part of the said body,
c) weight or weights are adjustable in size and/or in number,
whereby the muscle, flesh or bone of the said body or limb will be massaged and strengthened and/or lose fatty tissue in the area of the said body or limb will be reduced.

18. A method and device as claimed in claim 17 wherein the said containers can all be inflated at one time or alternatively inflated one or more container at a time so that a portion of the said containers can be inflated and the rest left uninflated.

19. A method and device as claimed in claim 17 wherein the said inflatable containers adjacent to the body have protrusions facing the said body.

20. A method and device as claimed in claim 19 wherein the said protrusions are inflatable together with the said containers.

21. A method and device as claimed in claim 19 wherein the said protrusions are inflated independently of the said containers.

22. A method and device as claimed in claim 19 wherein the said protrusions are of various sizes in order to cause a variety of massage effects.

23. A method and device as claimed in claim 19 wherein the said protrusions have a rough or hard surface in order to cause a variety of massage effects and better grip the said body.

24. A method and device as claimed in claim 19 wherein the said protrusions are made of a relatively soft, flexible air-tight substance.

25. A method and device as claimed in claim 17 wherein the said weights are held together with elastic material.

26. A method and device as claimed in claim 19 wherein there is a means that the said protrusions will aid rubbing into the said body or skin, liquids.

27. A method and device as claimed in claim 1 wherein the said weights are held together with elastic material.
